(19) United States
(12) Patent Application Publication
(10) Pub. No.: US 2023/0310269 A1
(43) Pub. Date: Oct. 5, 2023

(54) SUSPENDED MOXIBUSTION DEVICE

(71) Applicant: WUYI UNIVERSITY, Jiangmen (CN)

(72) Inventors: Xiaowei WANG, Jiangmen (CN); Zhide LI, Jiangmen (CN); Yuan ZHANG, Jiangmen (CN); Xiaojia SHI, Jiangmen (CN); Hongxu CHEN, Jiangmen (CN)

(73) Assignee: WUYI UNIVERSITY, Jiangmen (CN)

(21) Appl. No.: 17/841,616

(22) Filed: Jun. 15, 2022

(30) Foreign Application Priority Data
Apr. 1, 2022 (CN) 202210338833.3

(51) Int. Cl. A61H 39/06

(52) U.S. Cl. CPC A61H 39/06; A61H 2201/0207; A61H 2201/12

(57) ABSTRACT

A suspended moxibustion device including a mounting base, a suspended moxibustion head, a motor, a link lever and a crank. The mounting base includes a first and second mounting positions. The suspended moxibustion head includes a suspended moxibustion body with a mounting piece for mounting a moxa stick and is rotatably connected to the first mounting position. The motor is connected to one end of the suspended moxibustion head away from the suspended moxibustion body, and an output shaft of the motor is parallel to a rotating axis of the suspended moxibustion head. One end of the link lever away from the motor is rotatably connected to the second mounting position. The crank is perpendicular to the output shaft, one end of the crank is connected with the output shaft, and another end of the crank is rotationally connected to one end of the link lever close to the motor.

### CROSS-REFERENCE TO RELATED APPLICATION

This application is based on and claims the benefit of priority from Chinese Patent Application No. 2022103388333, filed on 1 Apr. 2022, the entirety of which is incorporated by reference herein.

### TECHNICAL FIELD

The disclosure relates to the technical field of moxibustion devices, and more particularly, to a suspended moxibustion device.

### BACKGROUND

Moxibustion is a therapeutic method that uses moxa heat generated by moxa sticks to stimulate acupoints or specific parts on a body surface, and adjusts physiological and biochemical functions of human body disorder by stimulating activities of meridian qi, so as to achieve the object of preventing and treating diseases. Moxibustion instruments are used for moxibustion, but some moxibustion instruments can only carry out fixedly-suspended moxibustion, but cannot realize rotary moxibustion.

### SUMMARY

The disclosure aims at solving at least one of the technical problems in the existing technology. Therefore, the disclosure provides a suspended moxibustion device capable of realizing rotary moxibustion.

A suspended moxibustion device according to the embodiments of the disclosure includes a mounting base, a suspended moxibustion head, a motor, a link lever and a crank, wherein the mounting base is provided with a first mounting position and a second mounting position spaced apart from the first mounting position; the suspended moxibustion head includes a suspended moxibustion body, the suspended moxibustion body is provided with a mounting piece for mounting a moxa stick, and the suspended moxibustion head is rotatably connected to the first mounting position; the motor is fixedly connected to one end of the suspended moxibustion head far away from the suspended moxibustion body, and an output shaft of the motor is parallel to a rotating axis of the suspended moxibustion head; one end of the link lever far away from the motor is rotatably connected to the second mounting position; and the crank is perpendicular to the output shaft, and one end of the crank is connected with the output shaft, so that the motor is capable of driving the crank to rotate, and the other end of the crank is rotationally connected to one end of the link lever close to the motor.

The suspended moxibustion device according to the embodiments of the disclosure at least has the following beneficial effects: the output shaft of the motor rotates to drive the crank to rotate, thus driving the link lever to swing left and right. As the suspended moxibustion head is rotatably connected to the first mounting position, one end of the link lever close to the suspended moxibustion head is rotatably connected to the second mounting position, and the motor is fixedly connected to end of the suspended moxibustion head far away from the suspended moxibustion body, the motor and the suspended moxibustion head will swing along with the swing of the link lever, thus realizing rotary moxibustion.

According to an embodiment of the disclosure, the mounting base includes a first boss and a second boss, and a wear-reducing piece connected above the first boss and the second boss, and the first mounting position and the second mounting position are arranged on the wear-reducing piece.

According to an embodiment of the disclosure, the first mounting position is a first connecting hole, the second mounting position is a second connecting hole, the suspended moxibustion head is provided with a connecting structure, the connecting structure includes a connecting post, the connecting post is arranged to penetrate through the first connecting hole, one end of the link lever far away from the motor is provided with a first connecting screw, and the first connecting screw is arranged to penetrate through the second connecting hole, so that the link lever is capable of rotating around the first connecting screw.

According to an embodiment of the disclosure, the mounting base includes a first boss and a second boss, the first mounting position is arranged on the first boss, the second mounting position is arranged on the second boss, the first mounting position is a third connecting hole, the second mounting position is a fourth connecting hole, the suspended moxibustion head is provided with a connecting structure, the connecting structure includes a connecting post, the connecting post is arranged to penetrate through the third connecting hole, one end of the link lever far away from the motor is provided with a first connecting screw, and the first connecting screw is arranged to penetrate through the fourth connecting hole, so that the link lever is capable of rotating around the first connecting screw.

According to an embodiment of the disclosure, the mounting base includes a first boss and a second boss, the first mounting position is arranged on the first boss, the second mounting position is arranged on the second boss, the first mounting position is a first connecting bulge, the second mounting position is a second connecting bulge, the suspended moxibustion head is provided with a connecting structure, the connecting structure is provided with a first mounting hole, the first connecting bulge is arranged to penetrate through the first mounting hole, one end of the link lever far away from the motor is provided with a second mounting hole, and the second connecting bulge is arranged to penetrate through the second mounting hole, so that the link lever is capable of rotating around the second connecting bulge.

According to an embodiment of the disclosure, the suspended moxibustion body is provided with a combustion chamber, an inner wall of the combustion chamber is provided with a first mounting port, and the mounting piece is connected to the first mounting port.

According to an embodiment of the disclosure, the mounting piece is arranged at one end of the suspended moxibustion body close to the motor, the mounting piece includes a storage barrel, the storage barrel is provided with an accommodating hole for accommodating the moxa stick along a length direction, the accommodating hole is communicated with the combustion chamber through the first mounting port, and the motor is fixedly connected to one end of the storage barrel far away from the suspended moxibustion body.

According to an embodiment of the disclosure, the mounting piece further includes a connecting rod with an external thread, one end of the storage barrel far away from the combustion chamber is provided with a second mounting port, the second mounting port is provided with an internal thread, the connecting rod is arranged to penetrate through the second mounting port and is screwed with the second mounting port, and one end of the connecting rod close to the suspended moxibustion body is configured for connecting the moxa stick.

According to an embodiment of the disclosure, the suspended moxibustion head further includes an ash cover connected to the suspended moxibustion body and covering the combustion chamber.

According to an embodiment of the disclosure, the ash cover includes a filter screen, a first magnetic ring, a second magnetic ring, a first hose clamp and a second hose clamp, the filter screen is connected to an inner peripheral side of the first magnetic ring, the first hose clamp is arranged around an outer peripheral side of the first magnetic ring and abuts against the first magnetic ring, the second magnetic ring is arranged on an outer wall of the suspended moxibustion body, the second hose clamp is arranged around an outer peripheral side of the second magnetic ring and abuts against the second magnetic ring, and the first magnetic ring is magnetically connected with the second magnetic ring.

According to an embodiment of the disclosure, the suspended moxibustion device further includes a smoke vent, wherein the smoke vent is connected to the suspended moxibustion body and is communicated with the combustion chamber.

According to an embodiment of the disclosure, the suspended moxibustion device further includes a stent and a case, wherein two ends of the stent are respectively connected to the mounting base and the case, and the smoke vent is communicated with the case.

According to an embodiment of the disclosure, the stent includes a first movable rod and a second movable rod, wherein the first movable rod is rotationally connected to the case and the second movable rod respectively, and the second movable rod is rotationally connected to the first movable rod and the mounting base respectively.

Part of the additional aspects and advantages of the disclosure will be given in part in the following description, and will become apparent in part from the following description, or will be learned through the practice of the disclosure.

### BRIEF DESCRIPTION OF THE DRAWINGS

The disclosure will be further explained with reference to the accompanying drawings and embodiments hereinafter, wherein:

FIG. 1 is a schematic diagram of a suspended moxibustion device according to an embodiment of the disclosure;

FIG. 2 is a schematic diagram of a partial structure of the suspended moxibustion device according to an embodiment of the disclosure;

FIG. 3 is an exploded schematic diagram of the partial structure of the suspended moxibustion device according to an embodiment of the disclosure;

FIG. 4 is an exploded schematic diagram of the partial structure of the suspended moxibustion device according to an embodiment of the disclosure;

FIG. 5 is a sectional view of a suspended moxibustion head of the suspended moxibustion device according to an embodiment of the disclosure; and

FIG. 6 is an exploded schematic diagram of the partial structure of the suspended moxibustion device according to an embodiment of the disclosure;

### REFERENCE NUMERALS

1000 refers to suspended moxibustion device;

100 refers to mounting base, 111 refers to first boss, 1111 refers to third connecting bulge, 112 refers to second boss, 1121 refers to fourth connecting bulge, 113 refers to wear-reducing piece, 1131 refers to first connecting hole, and 1132 refers to second connecting hole;

200 refers to suspended moxibustion head, 210 refers to suspended moxibustion body, 211 refers to combustion chamber, 2111 refers to first mounting port, 220 refers to connecting structure, 221 refers to connecting post, 230 refers to mounting piece, 231 refers to storage barrel, 2311 refers to accommodating hole, 2312 refers to end cover, 2302 refers to second mounting port, 232 refers to adjusting bolt, 240 refers to ash cover, 241 refers to filter screen, 242 refers to first magnetic ring, 243 refers to first hose clamp, 244 refers to second hose clamp, 245 refers to second magnetic ring, and 250 refers to connecting plate;

300 refers to motor, and 310 refers to output shaft;

400 refers to link lever, 410 refers to first connecting screw, and 420 refers to second connecting screw;

500 refers to crank;

600 refers to smoke vent;

700 refers to stent, 710 refers to first movable rod, and 720 refers to second movable rod; and

800 refers to case.

### DETAILED DESCRIPTION

The embodiments of the disclosure will be described in detail hereinafter. Examples of the embodiments are shown in the accompanying drawings. The same or similar reference numerals throughout the drawings denote the same or similar elements or elements having the same or similar functions. The embodiments described below with reference to the accompanying drawings are exemplary and are only intended to explain the disclosure, but should not be construed as limiting the disclosure.

In the description of the disclosure, it should be understood that the orientation or positional relationship indicated by the terms “upper”, “lower”, “inner”, “outer” and the like is based on the orientation or positional relationship shown in the drawings, only for the convenience of describing the disclosure and simplifying the description, and does not indicate or imply that the indicated device or element must have a specific orientation, or be constructed and operated in a specific orientation. Therefore, the terms should not be construed as limiting the disclosure.

In the description of the disclosure, if first and second are described, the descriptions are used for the purpose of distinguishing the technical features only, and cannot be understood as indicating or implying relative importance, or implicitly indicating the number of technical features indicated thereby, or implicitly indicating the order of technical features indicated thereby.

In the description of the disclosure, unless otherwise explicitly defined, words such as setting, installing and connecting should be understood a broad sense, and those skilled of ordinary skills in the art can reasonably determine the specific meanings of the above words in the disclosure in combination with the specific contents of the technical solutions.

Moxibustion instruments are apparatuses used for moxibustion, but some moxibustion instruments can only perform fixedly-suspended moxibustion, but cannot perform rotary moxibustion, and have poor moxibustion effects.

Fixedly-suspended moxibustion refers to a moxibustion method which aims a lit moxa stick without moving at a moxibustion site for smoked moxibustion at a distance of three to five centimeters from the skin.

Rotary moxibustion refers to a moxibustion method which moves a lit moxa stick in a reciprocating rotary manner above an acupoint area.

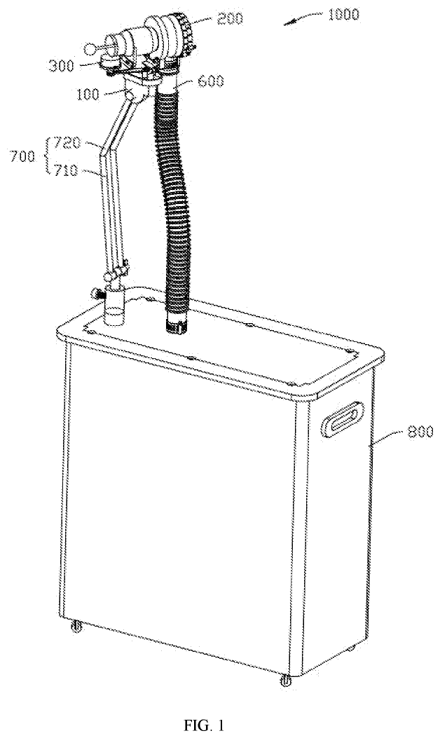

Therefore, an embodiment of the disclosure proposes a suspended moxibustion device 1000, which is specifically shown in FIG. 1 to FIG. 6.

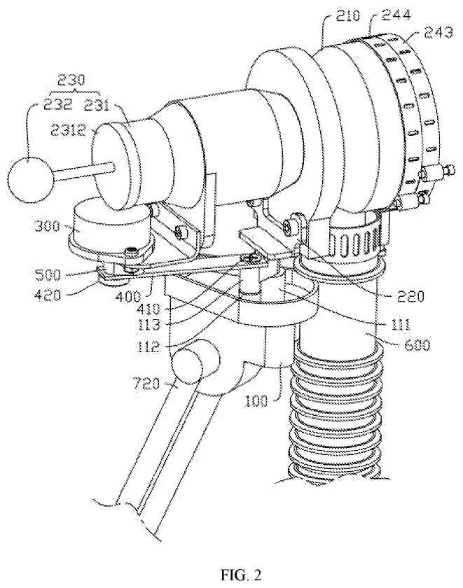

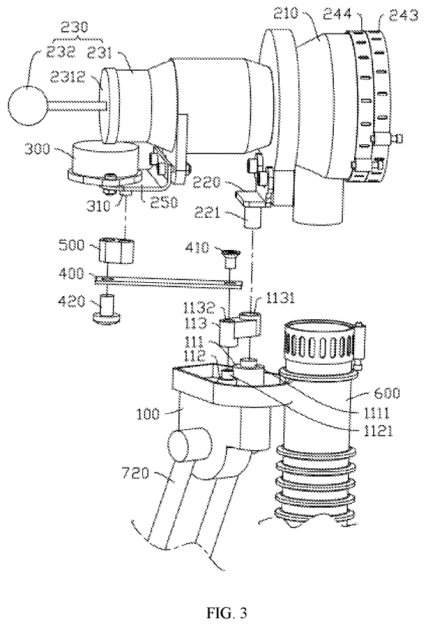

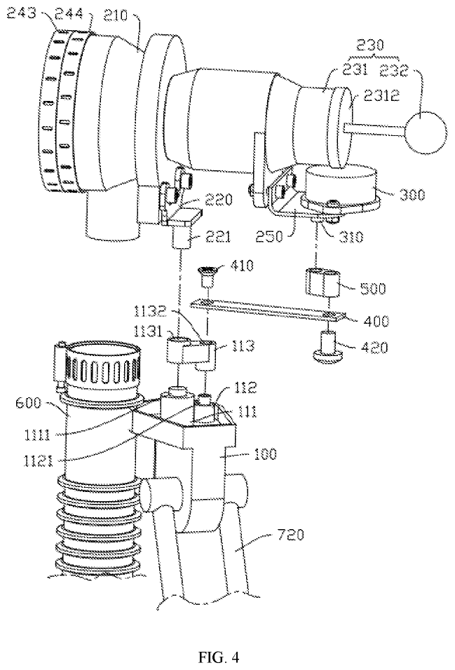

Referring to FIG. 1, FIG. 2, FIG. 3 and FIG. 4, in an embodiment, the suspended moxibustion device 1000 includes a mounting base 100, a suspended moxibustion head 200, a motor 300, a link lever 400 and a crank 500, wherein the mounting base 100 is provided with a first mounting position and a second mounting position spaced apart from the first mounting position. The suspended moxibustion head 200 includes a suspended moxibustion body 210, the suspended moxibustion body 210 is provided with a mounting piece 230 for mounting a moxa stick, and the suspended moxibustion head 200 is rotatably connected to the first mounting position. The motor 300 is fixedly connected to one end of the suspended moxibustion head 200 far away from the suspended moxibustion body 210, and an output shaft 310 of the motor 300 is parallel to a rotating axis of the suspended moxibustion head 200. One end of the link lever 400 far away from the motor 300 is rotatably connected to the second mounting position. The crank 500 is perpendicular to the output shaft 310, and one end of the crank 500 is connected with the output shaft 310, so that the motor 300 can drive the crank 500 to rotate, and the other end of the crank 500 is rotationally connected to one end of the link lever 400 close to the motor 300.

It may be understood that the motor 300 drives the crank 500 to rotate, and the crank 500 drives the link lever 400 to swing left and right. Under the swing of the link lever 400, the motor 300 may swing left and right along with the link lever. As the motor 300 is fixedly connected to the suspended moxibustion head 200, the suspended moxibustion head 200 may also swing integrally with the motor 300. In this case, the moxa stick mounted on the mounting piece 230 may also swing left and right, thus realizing rotary moxibustion.

It should be noted that a connecting plate 250 is arranged between the motor 300 and the suspended moxibustion head 200, and the connecting plate 250 is respectively connected to the motor 300 and the suspended moxibustion head 200 by screws.

It should be noted that the connecting plate 250 may also be connected to the motor 300 and the suspended moxibustion head 200 respectively by welding, or the like.

Obviously, the motor 300 and the suspended moxibustion head 200 may be directly connected by welding without the connecting plate 250.

It may be understood that when the motor 300 works, the crank 500 rotates around the output shaft 310 of the motor 300.

Referring to FIG. 3 and FIG. 4, in an embodiment, the mounting base 100 includes a first boss 111 and a second boss 112, and a wear-reducing piece 113 connected above the first boss 111 and the second boss 112, and the first mounting position and the second mounting position are arranged on the wear-reducing piece 113.

It may be understood that the wear-reducing piece 113 can prevent the suspended moxibustion head 200 and the link lever 400 from directly contacting with the mounting base 100, and reduce the wear of the suspended moxibustion head 200 and the link lever 400 during rotation.

It should be noted that the wear-reducing piece 113 is made of polyester material to improve a wear-reducing ability thereof.

Referring to FIG. 3 and FIG. 4, in an embodiment, the first mounting position is a first connecting hole 1131, the second mounting position is a second connecting hole 1132, the suspended moxibustion head 200 is provided with a connecting structure 220, the connecting structure 220 includes a connecting post 221, the connecting post 221 is arranged to penetrate through the first connecting hole 1131, one end of the link lever 400 far away from the motor 300 is provided with a first connecting screw 410, and the first connecting screw 410 is arranged to penetrate through the second connecting hole 1132, so that the link lever 400 is capable of rotating around the first connecting screw 410.

It may be understood that the connecting post 221 is arranged to penetrate through the first connecting hole 1131, so that the suspended moxibustion head 200 is capable of rotating around the connecting post 221.

It should be noted that the first boss 111 is provided with a third connecting bulge 1111, and the second boss 112 is provided with a fourth connecting bulge 1121. The third connecting bulge 1111 is matched with one end of the first connecting hole 1131, and the fourth connecting bulge 1121 is matched with one end of the second connecting hole 1132.

In another embodiment, an upper surface of the wear-reducing piece 113 is formed with a fifth connecting bulge (not shown in the figure) and a sixth connecting bulge (not shown in the figure) spaced apart from the fifth connecting bulge, the first mounting position is the fifth connecting bulge and the second mounting position is the sixth connecting bulge. In this case, the connecting structure 220 is provided with a third mounting hole (not shown in the figure), and one end of the link lever 400 far away from the motor 300 is provided with a fourth mounting hole (not shown in the figure). The third connecting bulge 1111 is matched with one end of the third connecting hole, and the fourth connecting bulge 1121 is matched with one end of the fourth connecting hole.

In this case, a lower surface of the wear-reducing piece 113 may be formed with a seventh connecting bulge (not shown in the figure) and an eighth connecting bulge (not shown in the figure) spaced apart from the seventh connecting bulge. The first boss 111 is provided with a fifth mounting hole (not shown in the figure), and the second boss 112 is provided with a sixth mounting hole (not shown in the figure). The seventh connecting bulge is matched with the fifth mounting hole and the eighth connecting bulge is matched with the sixth mounting hole.

In an embodiment, the mounting base 100 includes a first boss 111 and a second boss 112, the first mounting position is arranged on the first boss 111, the second mounting position is arranged on the second boss 112, the first mounting position is a third connecting hole (not shown in the figure), the second mounting position is a fourth connecting hole (not shown in the figure), the suspended moxibustion head 200 is provided with a connecting structure 220, the connecting structure 220 includes a connecting post 221, the connecting post 221 is arranged to penetrate through the third connecting hole, one end of the link lever 400 far away from the motor 300 is provided with a first connecting screw 410, and the first connecting screw 410 is arranged to penetrate through the fourth connecting hole, so that the link lever 400 is capable of rotating around the first connecting screw 410.

In another embodiment, the mounting base 100 includes a first boss 111 and a second boss 112, the first mounting position is arranged on the first boss 111, the second mounting position is arranged on the second boss 112, the first mounting position is a first connecting bulge (not shown in the figure), the second mounting position is a second connecting bulge (not shown in the figure), the suspended moxibustion head 200 is provided with a connecting structure 220, the connecting structure 220 is provided with a first mounting hole (not shown in the figure), the first connecting bulge is arranged to penetrate through the first mounting hole, one end of the link lever 400 far away from the motor 300 is provided with a second mounting hole (not shown in the figure), and the second connecting bulge is arranged to penetrate through the second mounting hole, so that the link lever 400 is capable of rotating around the second connecting bulge.

In an embodiment, one end of the link lever 400 close to the motor 300 is provided with a second connecting screw 420, and the crank 500 is rotatably connected to the second connecting screw 420.

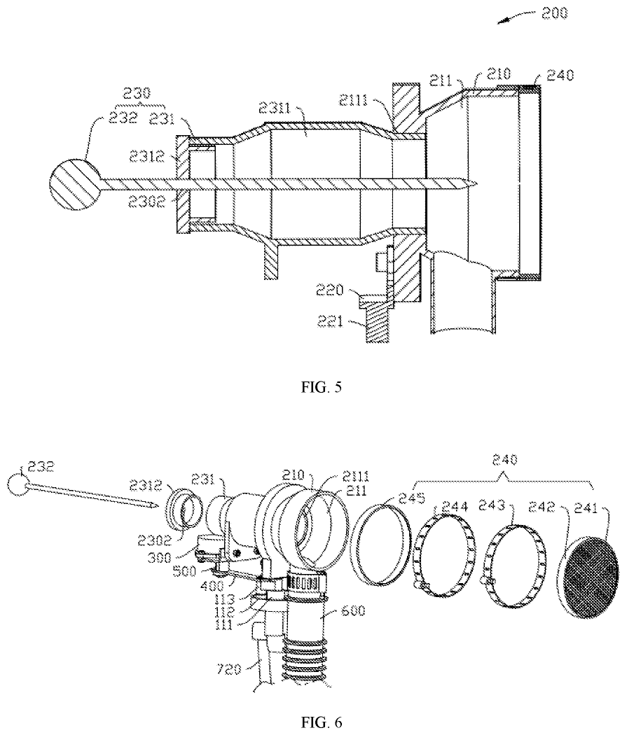

Referring to FIG. 5 and FIG. 6, in an embodiment, the suspended moxibustion body 210 is provided with a combustion chamber 211, an inner wall of the combustion chamber 211 is provided with a first mounting port 2111, and the mounting piece 230 is connected to the first mounting port 2111.

It may be understood that the moxa stick burns in the combustion chamber 211.

It should be noted that the mounting piece 230 may be a clamp or the like arranged on the suspended moxibustion body 210.

Referring to FIG. 5 and FIG. 6, in an embodiment, the mounting piece 230 is arranged at one end of the suspended moxibustion body 210 close to the motor 300, the mounting piece 230 includes a storage barrel 231, the storage barrel 231 is provided with an accommodating hole 2311 for accommodating the moxa stick along a length direction, the accommodating hole 2311 is communicated with the combustion chamber 211 through the first mounting port 2111, and the motor 300 is fixedly connected to one end of the storage barrel 231 far away from the suspended moxibustion body 210.

It may be understood that the moxa stick generally has a large length, and setting the storage barrel 231 can better accommodate the moxa stick.

Referring to FIG. 5 and FIG. 6, in an embodiment, the mounting piece 230 further includes a connecting rod with an external thread, one end of the storage barrel 231 far away from the combustion chamber 211 is provided with a second mounting port 2302, the second mounting port 2302 is provided with an internal thread, the connecting rod is arranged to penetrate through the second mounting port 2302 and is screwed with the second mounting port 2302, and one end of the connecting rod close to the suspended moxibustion body 210 is configured for connecting the moxa stick.

It may be understood that when the moxa stick becomes shorter as burning, the connecting rod may be adjusted to stretch out the moxa stick, so as to continue the suspended moxibustion.

It should be noted that one end of the storage barrel 231 far away from the combustion chamber 211 is provided with an end cover 2312, and the second mounting port 2302 is arranged in the end cover 2312.

Referring to FIG. 5 and FIG. 6, in an embodiment, the suspended moxibustion head 200 further includes an ash cover 240 connected to the suspended moxibustion body 210 and covering the combustion chamber 211.

It may be understood that the ash cover 240 can prevent ash generated by burning the moxa stick from falling out of the combustion chamber 211 to burn the skin of a user.

Referring to FIG. 6, in an embodiment, the ash cover 240 includes a filter screen 241, a first magnetic ring 242, a second magnetic ring 245, a first hose clamp 243 and a second hose clamp 244, the filter screen 241 is connected to an inner peripheral side of the first magnetic ring 242, the first hose clamp 243 is arranged around an outer peripheral side of the first magnetic ring 242 and abuts against the first magnetic ring 242, the second magnetic ring 245 is arranged on an outer wall of the suspended moxibustion body 210, the second hose clamp 244 is arranged around an outer peripheral side of the second magnetic ring 245 and abuts against the second magnetic ring 245, and the first magnetic ring 242 is magnetically connected with the second magnetic ring 245.

It may be understood that the way of connecting by the magnetic rings is beneficial to the disassembly and assembly of the ash cover 240, so as to facilitate the replacement of the moxa stick.

It should be noted that the ash cover 240 may also be connected to the suspended moxibustion body 210 by means of screw connection or the like.

It should be noted that both the first magnetic ring 242 and the second magnetic ring 245 are formed by curling soft magnetic strips.

Referring to FIG. 1, FIG. 5 and FIG. 6, in an embodiment, the suspended moxibustion device 1000 further includes a smoke vent 600, and the smoke vent 600 is connected to the suspended moxibustion body 210 and is communicated with the combustion chamber 211.

It may be understood that the moxa stick may generate smoke when burning in the combustion chamber 211, and the smoke vent 600 can guide the smoke out of the combustion chamber 211.

It should be noted that the smoke vent 600 may be connected with an exhaust fan and other devices to pump out the smoke out of the combustion chamber 211.

Referring to FIG. 1, in an embodiment, the suspended moxibustion device 1000 further includes a stent 700 and a case 800, wherein two ends of the stent 700 are respectively connected to the mounting base 100 and the case 800, and the smoke vent 600 is communicated with the case 800.

It may be understood that the smoke in the combustion chamber 211 is sucked into the case 800 from the smoke vent 600.

Referring to FIG. 1, in an embodiment, the stent 700 includes a first movable rod 710 and a second movable rod 720, wherein the first movable rod 710 is rotationally connected to the case 800 and the second movable rod 720 respectively, and the second movable rod 720 is rotationally connected to the first movable rod 710 and the mounting base 100 respectively.

It may be understood that through the first movable rod 710 and the second movable rod 720, the suspended moxibustion head 200 may be lifted up and down, so as to better carry out suspended moxibustion on different human body positions.

The embodiments of the disclosure are described in detail with reference to the above drawings. Finally, it should be noted that the above embodiments are only used to illustrate the technical solutions of the disclosure, but not to limit the technical solutions. Although the disclosure has been described in detail with reference to the above embodiments, those of ordinary skills in the art should understand that he can still make modifications or equivalent substitutions to the technical solutions described in the foregoing embodiments, or equivalently replace some or all technical features thereof. However, these modifications or substitutions do not make the essence of the corresponding technical solutions depart from the scope of the technical solutions of various embodiments of the disclosure.

1. A suspended moxibustion device, comprising:
a mounting base provided with a first mounting position and a second mounting position spaced apart from the first mounting position;
a suspended moxibustion head comprising a suspended moxibustion body, wherein the suspended moxibustion body is provided with a mounting piece for mounting a moxa stick, and the suspended moxibustion head is rotatably connected to the first mounting position;
a motor fixedly connected to one end of the suspended moxibustion head far away from the suspended moxibustion body, wherein an output shaft of the motor is parallel to a rotating axis of the suspended moxibustion head;
a link lever, wherein one end of the link lever far away from the motor is rotatably connected to the second mounting position; and
a crank perpendicular to the output shaft, wherein one end of the crank is connected with the output shaft, so that the motor is capable of driving the crank to rotate, and the other end of the crank is rotationally connected to one end of the link lever close to the motor.

2. The suspended moxibustion device according to claim 1, wherein the mounting base comprises a first boss and a second boss, and a wear-reducing piece connected above the first boss and the second boss, and the first mounting position and the second mounting position are arranged on the wear-reducing piece.

3. The suspended moxibustion device according to claim 2, wherein the first mounting position is a first connecting hole, the second mounting position is a second connecting hole, the suspended moxibustion head is provided with a connecting structure, the connecting structure comprises a connecting post, the connecting post is arranged to penetrate through the first connecting hole, one end of the link lever far away from the motor is provided with a first connecting screw, and the first connecting screw is arranged to penetrate through the second connecting hole, so that the link lever is capable of rotating around the first connecting screw.

4. The suspended moxibustion device according to claim 1, wherein the mounting base comprises a first boss and a second boss, the first mounting position is arranged on the first boss, the second mounting position is arranged on the second boss, the first mounting position is a third connecting hole, the second mounting position is a fourth connecting hole, the suspended moxibustion head is provided with a connecting structure, the connecting structure comprises a connecting post, the connecting post is arranged to penetrate through the third connecting hole, one end of the link lever far away from the motor is provided with a first connecting screw, and the first connecting screw is arranged to penetrate through the fourth connecting hole, so that the link lever is capable of rotating around the first connecting screw.

5. The suspended moxibustion device according to claim 1, wherein the mounting base comprises a first boss and a second boss, the first mounting position is arranged on the first boss, the second mounting position is arranged on the second boss, the first mounting position is a first connecting bulge, the second mounting position is a second connecting bulge, the suspended moxibustion head is provided with a connecting structure, the connecting structure is provided with a first mounting hole, the first connecting bulge is arranged to penetrate through the first mounting hole, one end of the link lever far away from the motor is provided with a second mounting hole, and the second connecting bulge is arranged to penetrate through the second mounting hole, so that the link lever is capable of rotating around the second connecting bulge.

6. The suspended moxibustion device according to claim 1, wherein the suspended moxibustion body is provided with a combustion chamber, an inner wall of the combustion chamber is provided with a first mounting port, and the mounting piece is connected to the first mounting port.

7. The suspended moxibustion device according to claim 6, wherein the mounting piece is arranged at one end of the suspended moxibustion body close to the motor, the mounting piece comprises a storage barrel, the storage barrel is provided with an accommodating hole for accommodating the moxa stick along a length direction, the accommodating hole is communicated with the combustion chamber through the first mounting port, and the motor is fixedly connected to one end of the storage barrel far away from the suspended moxibustion body.

8. The suspended moxibustion device according to claim 7, wherein the mounting piece further comprises a connecting rod with an external thread, one end of the storage barrel far away from the combustion chamber is provided with a second mounting port, the second mounting port is provided with an internal thread, the connecting rod is arranged to penetrate through the second mounting port and is screwed with the second mounting port, and one end of the connecting rod close to the suspended moxibustion body is configured for connecting the moxa stick.

9. The suspended moxibustion device according to claim 6, wherein the suspended moxibustion head further comprises an ash cover connected to the suspended moxibustion body and covering the combustion chamber.

10. The suspended moxibustion device according to claim 9, wherein the ash cover comprises a filter screen, a first magnetic ring, a second magnetic ring, a first hose clamp and a second hose clamp, the filter screen is connected to an inner peripheral side of the first magnetic ring, the first hose clamp is arranged around an outer peripheral side of the first magnetic ring and abuts against the first magnetic ring, the second magnetic ring is arranged on an outer wall of the suspended moxibustion body, the second hose clamp is arranged around an outer peripheral side of the second magnetic ring and abuts against the second magnetic ring, and the first magnetic ring is magnetically connected with the second magnetic ring.
